(19) United States
(12) Patent Application Publication
(10) Pub. No.: US 2008/0172468 A1
(43) Pub. Date: Jul. 17, 2008

(54) Virtual email method for preventing delivery of unsolicited and undesired electronic messages

(76) Inventor: John Almeida, Berkeley, CA (US)

Correspondence Address: LOUIS VENTRE JR, 2483 Oakton Hills Dr., OAKTON, VA, 22124, US

(21) Appl. No.: 11/623,300

(22) Filed: Jan. 15, 2007

(51) Int. Cl. G06F 15/16

(52) U.S. Cl. 709/206

(57) ABSTRACT

A method for an email recipient to assign individual virtual emails to each email sender to the email recipient and the assigned virtual email having at least two parts. That is, one part being the recipient email account and the other part being the sender ID for the sender. In case there are three parts, one part will be the recipient email account, another part the sender ID and the other additional part the recipient preset filter. As well, the two parts can be, one part for the recipient's email account and the other part for the email recipient's preset filter. Furthermore, a means for sending a page to the email sender prompting the sender for an answer that cannot be answered by a machine and it will be sent automatically by the email server whenever a sender sends an email message to the recipient's main email account or to a virtual account that is not yet setup.

### BACKGROUND OF INVENTION

1. Field of the Invention

This invention relates to a method where an email recipient assign a virtual email account to each email sender thus preventing deliver of unsolicited and undesired electronic messages.

2. Prior Art

Many vendors of electronic mail servers, as well as many third-party vendors, offer spam-blocking software to detect, label and sometimes automatically remove spam. Presently, there exist many methods for detecting, labeling and removing spam. Representative methods are taught in the following U.S. patents, the disclosures of which are hereby incorporated by reference herein:

U.S. Pat. No. 5,999,932 System and Method for Filtering Unsolicited Electronic Mail Messages Using Data Matching and Heuristic Processing; U.S. Pat. No. 6,023,723 Method and System for Filtering Unwanted Junk E-Mail Utilizing a Plurality of Filtering Mechanisms; U.S. Pat. No. 6,029,164 Method and Apparatus for Organizing and Accessing Electronic Mail Messages Using Labels and full Text and Label Indexing; U.S. Pat. No. 6,092,101 Method for Filtering Mail Messages for a Plurality of Client Computers Connected to a Mail Service System; U.S. Pat. No. 6,161,130 Technique Which Utilizes a Probalistic Classifier to Detect “Junk” E-Mail by Automatically Updating A Training and Re-Training the Classifier Based on the Updated Training List; U.S. Pat. No. 6,167,434 Computer Code for Removing Junk E-Mail Messages; U.S. Pat. No. 6,199,102 Method and System for Filtering Electronic Messages; U.S. Pat. No. 6,249,805 Method and System for Filtering Unauthorized Electronic Mail Messages; U.S. Pat. No. 6,266,692 Method for Blocking All Unwanted E-Mail (Spam) Using a Header-Based Password; U.S. Pat. No. 6,324,569 Self-Removing EmailVerified or Designated as Such by a Message Distributor for the Convenience of a Recipient; U.S. Pat. No. 6,330,590 Preventing Delivery of Unwanted Bulk E-Mail; U.S. Pat. No. 6,421,709 E-Mail Filter and Method Thereof; U.S. Pat. No. 6,484,197 Filtering Incoming E-Mail; U.S. Pat. No. 6,487,586 Self-Removing Email Verified or Designated as Such by a Message Distributor for the Convenience of a Recipient; U.S. Pat. No. 6,493,007 Method and Device for Removing Junk E-Mail Messages; U.S. Pat. No. 6,654,787 Method and Apparatus for Filtering E-Mail; 2005/0251861 System and method for preventing delivery of unsolicited and undesired electronic messages by key generation and comparison; 2005/0210106 System and method for detecting and filtering unsolicited and undesired electronic messages; 2005/0165895 Classification of electronic mail into multiple directories based upon their spam-like properties.

Many algorithms exist for processing incoming e-mail and grading the spamming of the e-mail. Some representative algorithms are taught in the foregoing patents whereas others are taught in the following publications, the disclosures of which are hereby incorporated by reference herein.

Hooman Katirai, Filtering Junk E-Mail: A Performance Comparison between Genetic Programming and Nave Bayes, Sep. 10, 1999. Jefferson Provost, Nave-Bayes vs. Rule-Learning in Classification of Email, Technical Report AI-TR-99-284. Mehran Sahami, Susan Dumais, David Heckerman & Eric Horvitz, A Bayesian Approach to Filtering Junk E-Mail, www.paulgram.com Paul Graham, Stopping Spam, August 2003, www.paulgram.com Paul Graham, So Far So Good, August 2003, www.paulgram.com Paul Graham, Filters That Fight Back, August 2003, www.paulgram.com Paul Graham, Better Bayesian Filtering, January, 2003, www.paulgram.com

Unfortunately, it is often the case that the predetermined threshold, coupled with the inherent inaccuracies of the algorithm employed for grading of the incoming e-mail for spamming, results in some e-mail being misclassified as spam when it is not, or visa versa. Obviously, as incoming mail is assigned a high score based upon its level of spamming, the likelihood of classifying incoming e-mail as spam increases as the threshold is decreased. However, this disadvantageously results in a greater likelihood of non-spam e-mails being misclassified as spam and consequently being overlooked and not read by the recipient. Conversely, increasing the threshold decreases the chance that non-spam e-mails are misclassified as spam.

The use of a spamming threshold thus results in a paradox of being, on the one hand, too guarded of potentially misclassifying non-spam e-mails as spam by raising the threshold too high whereupon a significant number of spam e-mails would fail to be identified as spam and remain in the recipient's Inbox and, on the other hand, being too aggressive by reducing the threshold resulting in non-spam e-mails being classified as spam. Consequently, the recipient is often faced with the dilemma of having an inbox with significant amounts of spam or having to frequently scan the presumed spam e-mail in the spam directory to verify that a legitimate e-mail was not improperly moved to the spam directory.

As taught by several of the above-referenced patents, there exist spam filters that grade the spamming of incoming e-mail by processing the e-mail for spam-like properties along a scale (e.g. 0-100) and if the incoming e-mail is graded to have a spamming level above a predetermined numeric threshold (e.g., above 80), the e-mail is automatically moved from the recipient's Inbox into a spam directory. Ideally, all of the spam will be moved to the spam directory, thereby obviating the need for the recipient to read the e-mail in the spam directory. As used herein, the term “spamming” may include undesired or unsolicited e-mails determined on a variety of objective and subjective scales including but not limited to politics, pornography and marketing scams.

In an attempt to overcome these drawbacks, Lindeman—Publication No. 2003/0009698 discloses a system for filtering Spam that relies upon the transmission of a “confirmation request” (hash value) by the Receiving Email System to the purported sender. The confirmation request is a reply email automatically generated by the Receiving Email System in response to any incoming email that does not originate from a whitelisted source or that may be potentially classified as Spam. The reply email requests that the original sender manually acknowledge the confirmation request in order for the sender to become a “trusted source.” This method relies on the inability of most spamming systems to respond to reply emails and the virtual impossibility that the spamming system could respond to a large number of them. If the confirmation email cannot be successfully delivered or if the system does not receive a reply to the request, then the Receiving Email System lists the mail as Spam and deletes it. Otherwise, if the Receiving Email System receives a reply, it adds the domain name to a trusted source list, or whitelist, and forwards the message to the intended recipient.

The drawback with Lindeman '698 is that if a spammer is of a sophisticated nature and possessing the resource, and in many case they are, the spammer can simply tune the email server to automatically responds to the emails requesting confirmation, not only that, the email server can retrieve the hash-code value and use it in subsequent spams.

The prior art Kind Code—Publication No. 2005/0165895 teaches a method that in additional to the conventional “Inbox” directory in which all incoming e-mails are normally received, the creation of a plurality of appropriately labeled directories for containing e-mails suspected of being spam, grading the level of spamming of the incoming e-mails and then moving or copying the incoming e-mails into one or more of the spam directories based upon the e-mails' respective levels of spamming.

The drawback with Kind Code '895 is that not only the user will need to be actively interacting with the spam filter and might requiring a great deal of time from the email recipient teaching the filter software and adjusting in a away that the software will direct emails to different directories based in the email recipient's settings. Furthermore, an astute spammer can easily overcome the filter by simply changing the spamming emails contents, headers, titles, etc., then the user once again having to get involved in setting new rules to direct the new class of spam to a different directory.

The prior art Cobb—U.S. Pat. No. 6,199,102 teaches a method to be used to filter emails sent by unlisted email senders and having a valid email address, the receiver email system will send a page having a question requiring the sender's reply and the reply can only be done by a human and not a machine, if the sender supplies the correct reply the email is placed at the recipients email box.

Although Cobb '102 teaches a means for stopping some email spamming, however it does not solves the problem, the fact is, lots of legitimate senders even some authorized by the email recipient that is not yet in the recipient's address book will not be able to interact with a recipient, for instance, if the legitimate sender is a user's bank and the user does not have the bank's email in the address book, the bank being a legitimate sender will not be able to use Cobb '102 because of the fact that most business will not allow their email server to receive automated replies for the simple reason that the email servers may become inundated with thousands, if not millions or emails requiring a request (e.g. the bank is sending end of the month banking statements), thus making Cobb '102 spam filter useless and becoming more of a hindrance than a solution. Therefore, it is an object of this invention to provide an improvement at which overcomes the aforementioned inadequacies of the prior arts and provides an improvement at which is a significant contribution to the advancement of the art of filtering spam.

### SUMMARY OF THE INVENTION

It is the object of this invention to demonstrate a method for blocking un-wanted electronic message more specifically email. The method is arranged to provide an additional code to the recipient email address such as to provide a virtual email to each email sender to the email recipient. Furthermore, the method will prevent the email recipient from receiving un-wanted emails without filtering out legitimate emails. A email address is subdivided into at least two parts, the first part is the recipient email address, the second part is the sender code, and if a third part if present, it will be the email recipient preset filter.

### BRIEF DESCRIPTION OF THE DRAWINGS

The accompanying drawings, which are incorporated in the form a part of this specification, illustrate embodiments of the invention and, together with the description, serve to explain the principles of the invention:

FIG. 1 illustrates a preferred embodiment wherein each email sender is assigned a virtual email.

FIG. 2 illustrates a process for sending and receiving email.

FIG. 3 illustrates a device for sending and receiving email.

FIG. 4 illustrates a confirmation process for allowing a user without assigned virtual email a means for verifying email authenticity.

FIG. 4a illustrates a filter means for automatically allowing a non-registered virtual email sender means for sending email without being required to confirm.

FIG. 5 illustrates an email structure having virtual emails for each email sender of the receiver email account.

FIG. 6 illustrates a screen exemplary view for virtual email management.

FIG. 7 illustrates a general email folder after the delete and archive processes of FIG. 6.

FIG. 8 illustrates individual folder after the delete and archive processes of FIG. 6.

FIG. 9 illustrates individual folder from a user's email address book being ported from the current in general use format to this invention's format using default setup.

FIG. 10 illustrates a further embodiment of FIG. 9 where individual folder from a user's email address book being ported from the current in general use format to this invention's format using virtual email settings.

### DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Once the background of the invention is fully explained its meanings and modes of uses will be clear and concise to those of the skill in the art and its superiority over all the prior art in the related field of stopping, filtering out un-wanted emails (junk emails, spam emails, unsolicited emails, etc., henceforth called un-wanted emails) without hindering the receiving of legitimate ones.

An email is subdivided into two parts by the “@” character, and they are: the first part before (left) the “@” character is the recipient's email address; and the second part (right) after the “@” character is the email server domain—name of the email server. Once a email sender sends a email to a email recipient, the sending server will parse the email and send it to the receiving email server, the server domain indicated at the right of the “@” sign. Once the email server receives the email it will match it against email recipient indicated on the left of the “@” sign. The process of email protocol will be explained shortly.

The present invention uses a process that involves dividing the recipient (left part before the “@” character) email address into at least two separate parts. The first part having the recipient's email address, the second part of the email is the email sender code (sender ID), and if a third part happens to be present therefore, it will have the email recipient preset filter. For instance, if the email recipient has the email address of, lets say, “myemail@emailserver.com” in this context the recipient email address is “myemail” and the email server domain is “emailserver.com” in the above example, anyone can send emails to “myemail” recipient, currently, the only way to stop un-wanted emails is by installing filters in the server domain “myemailserver.com” or by reconfiguring the server's email software to block un-wanted emails. In any of the just described solution the process is costly, time consuming and faulty. For the fact that any sophisticated email spammer, and in the majority of the cases they are, will be able to find ways of working around filters and emails server's configurations. Basically, Anyone possessing a recipients email address can send any number of emails to the email account and in most cases without any restriction whatsoever, that is, some email server use filters to filter out some incoming email and these filters varies from good to no avail. Actually, none are one hundred percent bullet proof against email spammers.

Lets move on and give a more in depth overview to the present invention. Since all the currently available solutions addresses the filtering of un-wanted emails in the email server side without having any consideration of the email recipient's concern, this invention address the email recipient instead and away from the just overviewed solutions addressing the email server's underlay technologies. The process involves in dividing the recipient's email address into two or more parts, and they follow. Lets use the above example “myemail@emailserver.com” now the email recipient “myemail” will assign an email to a email sender as to allow the receiving of emails from the email sender. In the aforementioned, the email address will be subdivided and lets say that the email sender is called “Bob Daily”. Now the email recipient will assign an email to “Bob Daily” and the assigned email might be “emailsender-bday@emailserver.com” now the only one having this email will be “Bob Daily”. The third part if present will be for setting a filter so all the emails bearing the filter will be automatically received. This process henceforth will be called virtual-email and its full use will be explained shortly. Next we'll give an overview of email communication.

I) Background of Email Communication

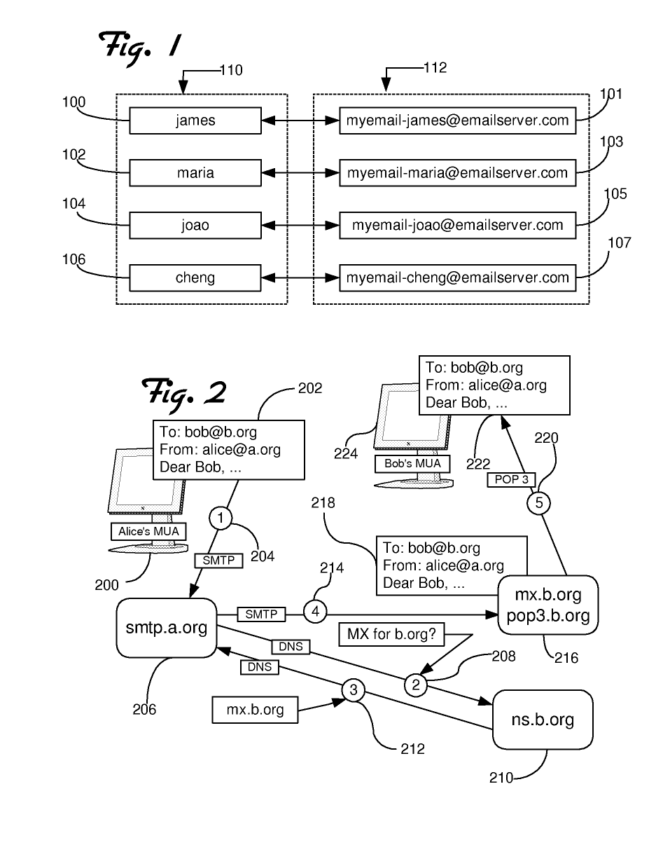

As we turn to FIG. 2 it illustrates the process involving email sending and receiving using the Internet. The diagram of FIG. 2 illustrates a typical sequence of events that takes place when Alice composes a message 202 using her Mail User Agent (MUA) 200. She types in, or selects from an address book, the e-mail address of her correspondent. She hits the “send” button.

1. Her MUA 200 formats the message of the Internet e-mail format and uses the Simple Mail Transfer Protocol (SMTP) 204 to send the message to the local Mail Transfer Agent (MTA), in this case smtp.a.org 206, run by Alice's Internet Service Provider (ISP).

2. The MTA 206 looks at the destination address provided in the SMTP protocol (not from the message header) 208, in this case bob@b.org. An Internet e-mail address is a string of the form localpart@domain.example, which is known as a Fully Qualified Domain Address (FQDA). The part before the @ sign is the local part of the address, often the username of the recipient, and the part after the @ sign is a domain name. The MTA looks up this domain name in the Domain Name System (DNS) to find the mail exchange servers accepting messages for that domain 210.

3. The DNS server for the b.org domain, ns.b.org 210, responds with an MX record listing the mail exchange servers for that domain, in this case mx.b.org 212, a server run by Bob's ISP.

4. smtp.a.org 206 sends the message 214 to mx.b.org 216 using SMTP, which delivers it to the mailbox of the user bob 218.

5. Bob presses the “get mail” button in his MUA 224, which picks up the message using the Post Office Protocol (POP3) 220 then reads it 222.

This sequence of events applies to the majority of e-mail users. However, there are many alternative possibilities and complications to the e-mail system:
Alice or Bob may use a client connected to a corporate e-mail system, such as IBM's Lotus Notes or Microsoft's Exchange. These systems often have their own internal e-mail format and their clients typically communicate with the e-mail server using a vendor-specific, proprietary protocol. The server sends or receives e-mail via the Internet through the product's Internet mail gateway, which also does any necessary reformatting. If Alice and Bob work for the same company, the entire transaction may happen completely within a single corporate e-mail system.
Alice may not have a MUA on her computer but instead may connect to a webmail service.
Alice's computer may run its own MTA, so avoiding the transfer at step 1.
Bob may pick up his e-mail in many ways, for example using the Internet Message Access Protocol, by logging into mx.b.org 216 and reading it directly, or by using a webmail service.
Domains usually have several mail exchange servers so that they can continue to accept mail when the main mail exchange server is not available.

It used to be the case that many MTAs would accept messages for any recipient on the Internet and do their best to deliver them. Such MTAs are called open mail relays. This was important in the early days of the Internet when network connections were unreliable. If an MTA couldn't reach the destination, it could at least deliver it to a relay that was closer to the destination. The relay would have a better chance of delivering the message at a later time. However, this mechanism proved to be exploitable by people sending unsolicited bulk e-mail and as a consequence very few modern MTAs are open mail relays, and many MTAs will not accept messages from open mail relays because such messages are very likely to be spam.

Note that the people, e-mail addresses and domain names in this explanation are fictional. Next we'll overview of email sender and receiver device.

II) Email Sender and Receiver Device

As we turn to FIG. 3 it illustrates the electronic configuration for the devices used for the email communication process. As it is understood by those skilled in the art, not all components may be shown for all devices or some devices may not have all of the shown components, still other devices may have more components than those presented in the drawings. It is done as is for sake of simplicity in presenting this invention and not intended to obscure its meaning and mode of use.

Now as we view the device 300 it has a Central Processing Unit (CPU) 302 and it is the brain of the device controlling the device's functionalities. The device 300 has programming code means for its initialization at power up and it is usually stored in the permanent storage medium, and in this case it is in a Read Only Memory (ROM) 304 it can be stored in other permanent storage medium as well. After power up the CPU 302 will read the programming code from the ROM 304 and starts processing it and it will load an Operating System (OS) 316 from the storage device 306 into the Read Access Memory (RAM) 312. The OS 316 will load software applications 318 as needed into the RAM 312 and as applications 318 are executed and their interaction will be presented to the user at the display 310. As needed the OS 316 will receive input from others devices that are interfaced with the device 300 by using its Input Output (IO) port 308, the devices can be but not limited to: mouse, keyboard, touch screen, etc. It will send output to other interfacing devices as well, such as but not limited to: screen, printer, audio card, video card, etc. Once the device 300 hundred receives or sends email it will use the Network Interface 314. Next we'll overview spam and its implications.

III) Background of Spam

Spammers frequently disguise their messages with obfuscated text. As the recipient directly bears the cost of delivery, storage, and processing, one could regard spam as the electronic equivalent of “postage-due” junk mail. However, this does not mean that all commercial email is spam; for example, some recipients may have opted in (i.e., willingly chosen) to receive the marketer's email.

Spam is sent by organizations of varying sizes and motivations. Some are large, well-known companies; spam from these sources is sometimes called mainsleaze. Advance fee fraud spam such as the Nigerian “419” scam may be sent by a single individual from a cyber cafe in a developing country. Most alarming are organized criminal gangs. These often operate from Russia or Eastern Europe, and share many features in common with other forms of organized crime such as turf battles and revenge killings.

Spammers may engage in deliberate fraud to send out their messages. Spammers often use false names, addresses, phone numbers, and other contact information to set up “disposable” accounts at various Internet Service Providers (ISP). They also often use falsified or stolen credit card numbers to pay for these accounts. This allows them to move quickly from one account to the next as the host ISPs discover and shut down each one.

Senders may go to great lengths to conceal the origin of their messages. Large companies may hire another firm to send their messages so that complaints or blocking of email falls on a third party. Others engage in spoofing of e-mail addresses (much easier than Internet protocol spoofing). The e-mail protocol (SMTP) has no authentication by default, so the spammer can pretend to relay a message apparently from any e-mail address. To prevent this, some ISPs and domains require the use of SMTP-AUTH, allowing positive identification of the specific account from which the e-mail originates. Senders cannot completely spoof e-mail delivery chains (the ‘Received’ header), since the receiving mail server records the actual connection from the last mail server's IP address. To counter this, some spammers forge additional delivery headers to make it appear as if the e-mail had previously traversed many legitimate servers.

Spammers frequently seek out and make use of vulnerable third-party systems such as open mail relays and open proxy servers. The SMTP system, used to send e-mail across the Internet, forwards mail from one server to another; mail servers that ISPs run commonly require some form of authentication that the user is a customer of that ISP. Open relays, however, do not properly check who is using the mail server and pass all mail to the destination address, making it quite a bit harder to track down spammers.

Increasingly, spammers use networks of virus-infected PCs (zombies) to send their spam. Zombie networks are also known as Botnets. In June 2006, an estimated 80% of e-mail spamming were sent by zombie PCs, an increase of 30% from the prior year. An estimated 55 billion e-mail spam were sent each day in June 2006, an increase of 25 billion per day from June 2005.

Spoofing can have serious consequences for legitimate e-mail users. Not only can their e-mail inboxes get clogged up with “undeliverable” e-mails in addition to volumes of spam, they can mistakenly be identified as a spammer. Not only they may receive irate e-mail from spam victims, but (if spam victims report the e-mail address owner to the ISP, for example) their ISP may terminate their service for spamming.

E-mail spam is growing exponentially, with no signs of abating. The amount of spam users see in their mailboxes is just the tip of the iceberg, since spammers' lists often contain a large percentage of invalid addresses.

In absolute numbers
1978—An e-mail spam is sent to 600 addresses.
1994—First large-scale spam sent to 6000 newsgroups, reaching millions of people.
2005—(June) 30 billion per day.
2006—(June) 55 billion per day.
2006—(December) 85 billion per day.

Some individual receives over a million e-mail spam a year thus causing a great deal of lost time and no means available to simply stopping them at the source before reaching the recipient.

Some spam originate from a different country that of the recipient and some spam refers to the geographical location of the computer from which the spam is sent; it is not the country where the spammer resides, nor the country that hosts the spamvertised site. Due to the international nature of spam, often the spammer, the hijacked spam-sending computer, the spamvertised server, and the user target of the spam are all located in different countries.

Some countries are the source of more spam than others. Accordingly, the major sources of spam in the second quarter of 2006 (April to June) were the United States, China, Russia, and South Korea.

There are many anti-spam techniques available and many more are devised daily. Some popular methods for filtering and refusing spam include e-mail filtering based on the content of the e-mail, DNS (Domain Name Service)-based blackhole lists, greylisting, spamtraps, enforcing technical requirements, checksumming systems to detect bulk email, and by putting some sort of cost on the sender via a Proof-of-work system or a micropayment. Each method has strengths and weaknesses and each is controversial due to their weaknesses.

Detecting spam based on the content of the e-mail, either by detecting keywords such as “viagra” or by statistical means are very popular. They can be very accurate when they are correctly tuned to the types of legitimate email that an individual gets, but they can also make mistakes such as detecting the keyword “cialis” in the word “specialist”. The content also doesn't determine whether the email was either unsolicited or bulk, the two key features of spam. So, if a friend sends you a joke that mentions “viagra”, content filters can easily mark it as being spam even though it is both solicited and not bulk.

Enforcing technical requirements of the Simple Mail Transfer Protocol (SMTP) can be used to block mail coming from systems that are not compliant with the RFC standards. A lot of spammers use poorly written software or are unable to comply with the standards because they do not have legitimate control of the computer sending spam (zombie computer). So by setting restrictions on the Mail Transfer Administrator (MTA) a mail administrator can reduce spam significantly. In many situations, simply requiring a valid Fully Qualified Domain Name (FQDN) in the SMTP HELO statement is enough to block 25% of incoming spam.

Spam differs from other forms of direct marketing in many ways, one of them being that it costs no more to send to a larger number of recipients than a smaller number. For this reason, there is little pressure upon spammers to limit the number of addresses targeted in a spam run, or to restrict it to persons likely to be interested. One consequence of this fact is that many people receive spam written in languages they cannot read—a good deal of spam sent to English-speaking recipients is in Chinese or Korean, for instance. Likewise, lists of addresses sold for use in spam frequently contain malformed addresses, duplicate addresses, and addresses of role accounts such as postmaster.

Many regulations have been implemented by many governments, the more laws that are implemented, the more spammers find ways of overcoming them and making spam even harder to regulate, the fact is that lots of spam messages comes from overseas. This is a global problem that will reach mammoth proportions and laws alone can't stop spam.

IV) A Preferred Embodiment

Now we'll give a more in depth explanation of this invention and its superior solution over all of the aforementioned arts. As we turn to FIG. 1 and it illustrates what we've explained regarding the virtual-email. To the left of FIG. 1 we have four email senders 100, 102, 104 and 106 and they are illustrated in the email recipient's address list 110. As we analyze to the right 112 there is a group of virtual-email and each of the email having a virtual-email assigned to each email sender 101, 103, 105 and 107 shown on the left 110. Lets explain the first one 101 “myemail-james@emailserver.com” assigned to the email sender “james” 100. Once “james” 100 sends an email to the email recipient “myemail”, “james” will send the email using his virtual-email “myemail-james@emailserver.com”. Since this is only assigned to “james” 100 and if anyone spam it in the future, all that the email recipient will have to do is delete the virtual-email “myemail-james@emailserver.com” and the spam will be permanently blocked. If “james” 100 is an important contact of the email recipient, then a new virtual-mail can be created and the old one permanently deleted.

As we've explained elsewhere, the server at which “james” is sending the email to the email recipient “myemail-james@emailserver.com” will do all the communication and have the email sent by “james” directed to the server domain “emailserver.com” and once the “emailserver.com” receives the email it will first look for the email account “myemail” and if it exists it will further look for the sender id “james” that is part of the recipient's email account and place it in an appropriate folder/data base record assigned to “james” and under the recipient's email address “myemail”. Regarding the sender id that is part of the email recipient's account, it can be separated from the recipient's email account by using any character (we've used “-” character), or it can be specified in terms of location within the recipient's email account. For instance, the sender id for “james” could as well have been “myemail000james” and would've been interpreted as ten positions “myemail000” of the recipient email account and the second part the sender id “james”. Also, it can be based on the last part of the recipient's email account and the send id for “james” could as well have been “myemailjames0” and in this case the last six position are reserved for the user id “james0”. It can be setup in any conceivable way and only limited by the human imagination.

As explained in the preferred embodiment, it is clear how email spammers can be stopped without any sophisticated software at the recipient's email server. Although, this is a very efficient means of stopping spammer, there will be time that we need to allow others to send emails without having a specific email assigned to them, in the case of business cards, or in case the recipient assigns an email to a specific sender and forgets to set the receiver's virtual email account to receive the email. In both cases, both senders are legitimate and if no other means are configured in the recipient's email server, the emails have to be returned. Lets say that a business card has the email “myemail@emailserver.com”, or a virtual email “myemail-friend@emailserver.com” and each sends an email to the “emailserver.com”.

Since the objective of this invention is to stop spammers and not legitimate senders. A new way needs to be implemented to accommodate the just described situation. In either of the above cases, the first case where an email sender will send an email to the actual email receiver's account “myemail@emailserver.com” and it may be that the email is part of a business card, advertisement, etc. Next, the second case involves “myemail-friend@emailserver.com” an email that the recipient has just given to the intended email sender and the email recipient may forgot to set the virtual email account to “myemail-friend”, or didn't have the time to do so, etc. In both of the aforementioned cases, there must be a means for the email sender to be able to send emails to the email recipient, since they are legitimate senders.

Once an email is received and a virtual email is not yet assigned or the email is received by the actual recipient's email account, the email server will be programmed to send an email back to the sender asking the sender to confirm its identity and the confirmation will be in a format that only a human can reply to. The process works as following: the email server will send an email to the email sender account with a link identifying the email [1]; the user receive the email and clicks on the link [2]; the link will direct the user to a page from the email server where it originated [3]; the server will send a page to the email sender (user) asking for a reply that only a human can do [4]; the user provides the reply [5]; if the reply is the correct one, the email server will place the email into the recipient email box [6]; and a new page is sent back to the user notifying that the email has been delivered [7]. It can be done in many other ways as well and anyone with skill of the art will be able to conceive many other ways without departing from the true spirit and the teaching depicted herein.

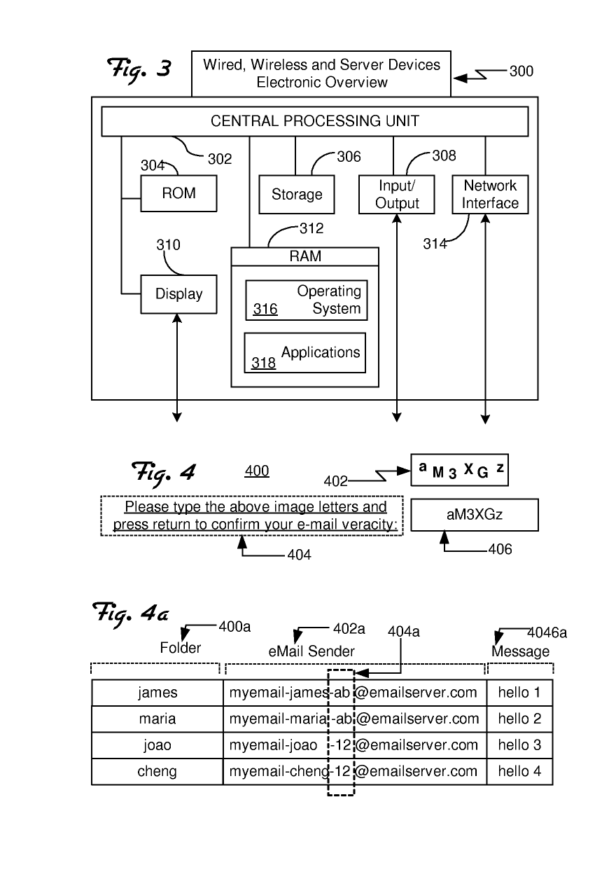

As we turn to FIG. 4, it illustrates one way of solving the two situations just described. The page sent to the sender 400 by the email server and asking the sender to supply an answer as a reply and the page having a machine generated image 402 (other means can be used as well like a question and so on); a question or instruction 404 and the receiving form text for the user to input the reply 406. As for our example, the image 402 contains machine generate character for a user to enter into the field 406 and they are: “aM3×Gz”. After the sender replies to the page, once the email server receive it and if the supplied answer is the correct one, than the email will be placed into the recipient email box. The image is used in our example since machines has difficulty in deciphering values placed on them. The image can be skewed before presenting it on a page, thus, making it even harder for an algorithm to guess its values.

One more exemplary explanation of using means for receiving a human reply involves the email server to send a page that will have images on it, lets say that there are four images (it can be any number), an elephant [1]; a giraffe [2]; a crocodile [3]; and a falcon [4], and the question might be: “please select an elephant” and the user will select the image with the elephant and the email server will authenticate the answer and place the email into the recipient's email box. It can be a combination of two or more images as well. It can be something like asking the user to choose images that have an specific background, color, format, etc.

There is at least one other way for creating a filter that will allow wanted emails to be received by the email recipient without hindering legitimate users. As we turn to FIG. 4a it is a further illustration of FIG. 1 and it illustrates the folder 400a assigned to the each user as at FIG. 1, and each user now having an addition extension assigned to each virtual email account 402a and for the first two users it is “ab” and for the last two users it is “12” 404a. The extension shown and assigned to each virtual email, is user (recipient) set as to allow the email server means for receiving legitimate emails before the virtual email account is setup. In the exemplary explanation for the two user, the filter “ab” was used and later changed to “12” for the last two users (it can as well be that they both are active filters). Since a spam will need to know the extension in terms to send un-wanted emails this will be unlikely to happen since the email recipient may change the filter often and any old filter becoming useless. Two characters were shown for the extension and a short value for the sender's ID. It is to be understood that in reality it can be any length and in most of the cases they are more than just a few characters.

Furthermore, the first positions can be the sender ID and the filter field, just the sender ID or just the filter field. E.g. “123jamesmyemail” the first three characters “123” is the filter, the next five characters “james” the sender ID and the rest of it is the receiver email account [1]; “123myemail” the first three characters the filter and the rest of it the receiver email account [2]; “jamesmyemail” the first five characters “james” the sender ID and the rest of it the receiver email account [3]. The email server can be setup to allow the email recipient to set one or more filters as well, for instance, e.g. a user setup two filters “abc” and “123” now all virtual emails having the filter fields of “abc” or “123” will be accepted. Moreover it can as well be like: “jamesmyemail12@emailserver.com”, “12myemailjames@emailserver.com”, etc, and for these two virtual emails “myemail-james-ab@emailserver.com” and “myemail-james-12@emailserver.com” are two distinct virtual emails; “james-myemail-ab@emailserver.com” and “james-myemail-12@emailserver.com” are two distinct virtual emails as well. Once again, any conceivable combination can be used and only limited by the human imagination. As long as the receiving email server is able to extract the recipient's email account from the virtual string, its purpose has been achieved.

In the case where extension filters are used for the purpose of allowing the receiving of incoming emails they will allow email into the recipients email box regardless if the sender's ID has been setup by the email recipient. Once any of the two aforementioned methods (for requesting confirmation of the use of a filter) are used, the recipient at the time of viewing the received emails will have the option to allow the email server to automatically create the virtual email for the email sender. Not all the functionality are shown for sake of simplicity and not intended to obscure this invention and those of the skill in the art will readily know how to implement them without departing from the true spirit of this invention. Since they can be a button or other means for asking permission from the email recipient to create the virtual email for the email sender. In the case of the first example “myemail@emailserver.com” the recipient will be given an option to setup a virtual email for the email sender and the email sender will be notified by email of the new virtual email accordingly.

As we now turn to FIG. 5 it illustrates a further embodiment of the arrangement of FIG. 1 and it depicts one way in the process of organizing folders to each virtual email sender. There are four folders 500, one for each user. The first user “james” 506 has three emails 504 assigned to his virtual email 502. The same is true for the other user 508, 510 and 512. This is just one way of organizing individual virtual email accounts and many more ways can be devised and implemented without departing from the true spirit of this invention.

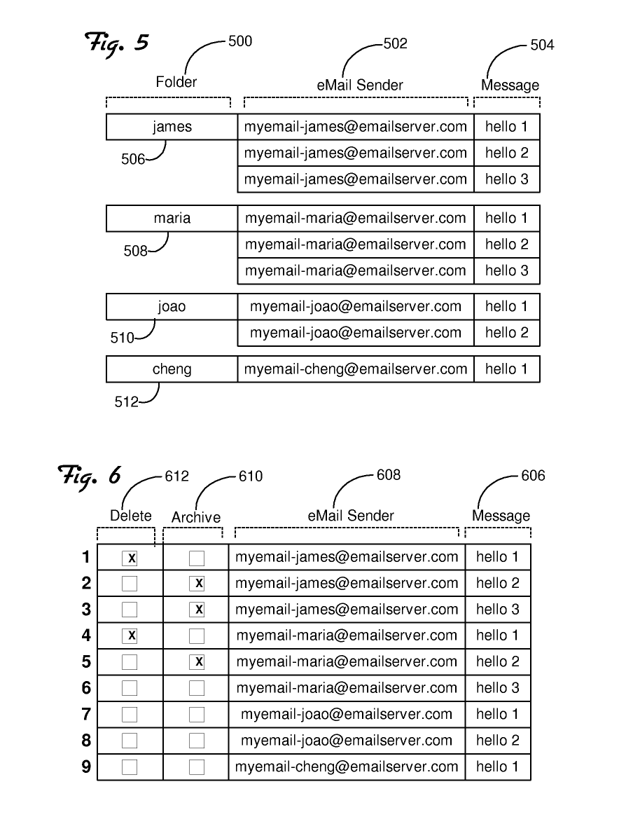

As we turn to FIG. 6 it illustrates a single page where the email recipient can manage all of the virtual emails at once. There is a delete column 612; an archive column 610 which once selected the emails will automatically be assigned to each individual folders of FIG. 5. The next two columns are for the virtual email accounts 608 and the virtual email messages 606. As we analyze the delete and archive columns—612 and 610 respectively they each have some boxes checked, the total of two for the delete column 612; the total of three for the archive column 610 and the total of four are left unchecked (rows 6-9).

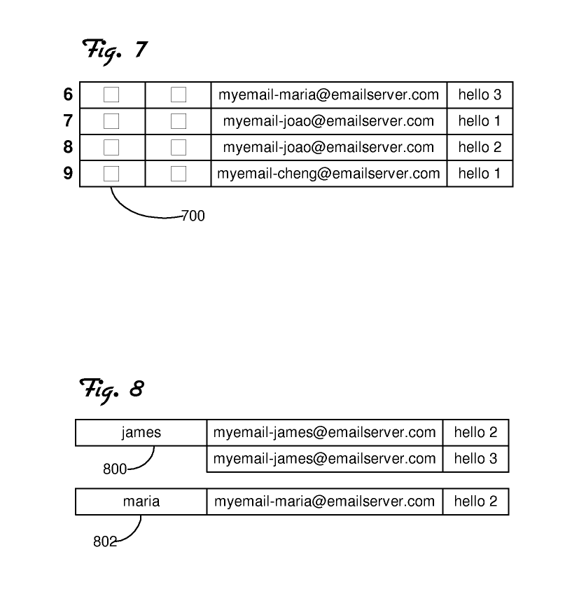

As we now turn to FIG. 7 it illustrates a new page list and having only the last four rows that wasn't checked (deleted or archived) 700 from the table of FIG. 6. Now FIG. 8 illustrates the two folders of the checked box of FIG. 6 of the archive column 610 which had the rows 2, 3 and 5 checked. They were messages “hello 2” and “hello 3” for “james” 800 rows 2 and 3 of FIG. 6; as for “maria” 802 it is just one and it is “hello 2” row 5 of FIG. 6.

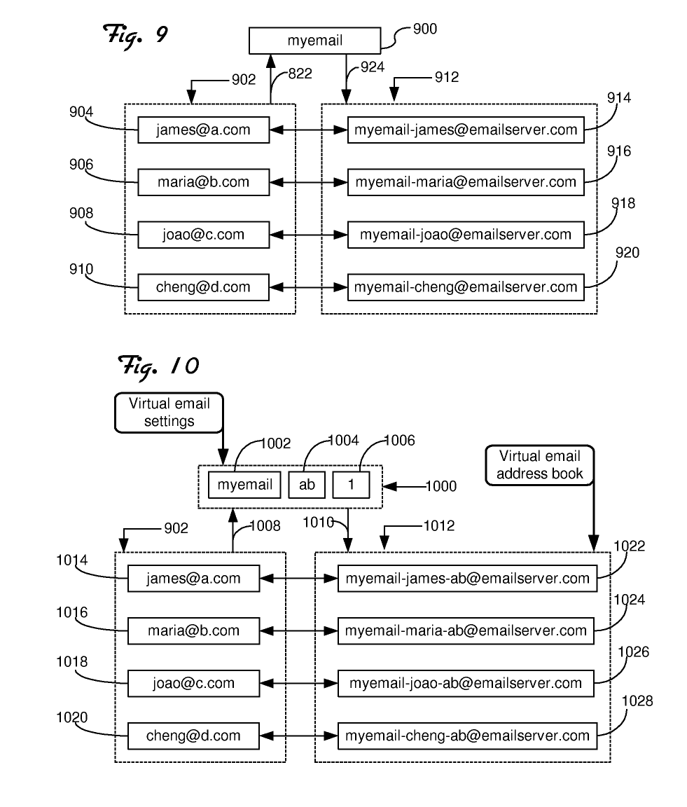

There will be a need to port current in use email format (two parts email format) from current email recipients' addresses book to a new address book having the new virtual email format and use the new virtual email format from the new created address book. As we turn to FIG. 9 it illustrates such a method. To the left we have an address book 902 and used by “myemail” user 900 and it has four emails 904, 906, 908 and 910 and the new format 912 shows each email ported to the new format using the default format therein, the email recipient ID “myemail” followed by the sender ID. As we proceed to FIG. 10 it illustrates just one more method and it depicts a set of parameters 1000, an email recipient “myemail” 1002, the filter parameter 1004 and the setting parameter 1006. Lets move on and explain the email setting parameter 1006. It is the parameter that will indicate what format the server will use for the recipient email format and as we saw in FIG. 9 the default parameter was used and it is set in FIG. 10 and it is the value of “1” which produces the same result as of FIG. 9, that is, the default parameter is “1”. The parameter can be of any value and not necessarily the ones shown for this example. For instance, it can “0” for the format “jamesmyemailab”; “2” for “abjamesmyemail”; “3” for “abemailjames”; “4” for “ab-james-myemail”; etc. Anyone skilled in the art will be able to create any conceivable combination and it is only limited to the human imagination. Once emails are ported to the new virtual email address book, the server may automatically generate emails and forward them to each recipient notifying of the new virtual email account setup therein.

Overview

A method has been presented for an email recipient to assign individual virtual emails to each email sender to the email recipient and the assigned virtual email having at least two parts. That is, one part being the recipient email account (it can be either the first or any other part of the virtual email) and the other part being the sender ID for the sender. In case there are three parts, one part will be the recipient email account, another part the sender ID and the other additional part the recipient preset filter. Once a recipient's preset filter is active, all the received virtual emails for the recipient are automatically assigned to the recipient's account. As noted, in can be in any arrangement and the recipient email account can be the first, the last, the middle part or any section of the virtual email. As well, the two parts can be, one part for the recipient's email account and the other part for the email recipient's preset filter. Furthermore, a means for sending a page to the email sender prompting the sender for an answer that cannot be answered by a machine and it will be sent automatically by the email server whenever a sender sends an email message to the recipient's main email account or to a virtual account that is not yet setup. All the names and domains used for our exemplary explanation are fictitious and not associated with names or domains known to applicant of this invention.

Although the present invention and its advantages have been described in detail, it should be understood that various changes, substitutions and alterations could be made herein without departing from the true spirit and scope of the invention as defined by the appended claims. Moreover, the scope of the present application is not intended to be limited to the particular embodiments of the process, machine, manufacture, composition of matter, means, methods, computer software and steps described in the specification. As one of ordinary skill in the art will readily appreciate from the disclosure of the present invention, processes, machines, manufacture, compositions of matter, means, methods, computer software, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, computer software or steps.

What is claimed is:

1. A method of a virtual email for filtering electronic messages, comprising:
at least one user, said at least one user having a electronic address;
at least one electronic message sender;
a server for receiving electronic messages, said server having means to manage said electronic address for said at least one user as to allow said at least one user to receive electronic messages sent to said server in behalf of said at least one user;
said at least one user's electronic address is divided into two or more parts;
said at least one user's electronic address having at least a first part wherein said at least fist part of said electronic address is an electronic address for identifying said server in a network;
said at least one user's electronic address having at least a second part wherein said at least second part of said electronic address is an user ID assigned to said at least one user and used by said server as a means for said server to identify said at least one user therein;
said at least one user's electronic address having at least a third part wherein said at least third part of said electronic address is a sender's ID set by said at least one user and assigned to said at least one electronic message sender as a means for authorizing said at least one electronic message sender to send electronic messages to said at least one user at said server; and
said at least one electronic message sender's ID is associated with said at least one user's ID and said server uses said association as means for directing said server to receive electronic message from said authorized at least one electronic message sender and assign received electronic message from said authorized at least one electronic message sender to said at least one user therein.

2. The method of a virtual email according to claim 1 further comprising:
said at least one user having a user's list for adding sender's ID; and
said server having means to add said authorized at least one electronic message sender's sender ID to said at least one user's list.

3. The method of a virtual email according to claim 2 further comprising:
means to remove said authorized at least one electronic message sender's sender ID from said at least one user's list.

4. The method of a virtual email according to claim 1 further comprising:
said server receives an electronic message from said authorized at least one electronic message sender in behalf of said at least one user therein; and
said received electronic message having an electronic address of said at least one authorized electronic message sender.

5. The method of a virtual email according to claim 4 further comprising:
if said at least one authorized electronic message sender's sender ID is not yet part of a list of said at least one user, said server having means to send a prompt back to said at least one authorized electronic message sender wherein said prompt is designed to be answered by a person and not a machine.

6. The method of a virtual email according to claim 4 wherein said electronic message is an email.

7. The method of a virtual email according to claim 4 further comprising:
if said at least one authorized electronic message sender's sender ID is part of a list of said at least one user's list, said server having means to assign said received electronic message from said at least one electronic message sender to said at least one user therein.

8. The method of a virtual email according to claim 1 further comprising:
said server having means to manage individual folder for each of said at least on user's authorized electronic message senders.

9. The method of a virtual email according to claim 8 wherein said means to manage includes means for creating individual folder for each of said at least one user's authorized electronic message senders.

10. The method of a virtual email according to claim 8 wherein said means to manage includes means for deleting individual folder for each of said at least one user's authorized electronic message senders.

11. The method of a virtual email according to claim 8 further comprising:
said server uses said means to manage individual folder and creates a folder for said at least one authorized electronic message sender.

12. The method of a virtual email according to claim 11 further comprising:
said server having means to assign received electronic messages sent by said at least one authorized electronic message sender to his/her folder.

13. The method of a virtual email according to claim 1 further comprising:
said server having means to manage electronic messages sent to said at least one user by a plurality of authorized electronic message senders which were authorized by said at least one user.

14. The method of a virtual email according to claim 13 wherein said means to manage electronic messages includes deleting electronic messages.

15. The method of a virtual email according to claim 13 wherein said means to manage electronic messages includes means to archive electronic messages to individual folder.

16. The method of a virtual email according to claim 1 further comprising:
said at least one user's electronic address having at least a forth part wherein said at least forth part of said electronic address is a filter part of a configuration set by said at least one user with said server;

17. The method of a virtual email according to claim 16 further comprising:
if said filter is active at said server said server will assign all received electronic messages sent to said at least one user regardless if an authorized electronic message sender's sender ID is part of said at least one user's list therein.

18. The method of a virtual email according to claim 16 further comprising:
said server receives an electronic message from said at least one authorized electronic message sender in behalf of said at least one user therein;
said received electronic message having an address of said at least one authorized electronic message sender; and
if said filter is not active and said at least one authorized electronic message sender's sender ID is not yet part of a list of said at least one user, said server having means to send a prompt back to said at least one authorized electronic message sender wherein said prompt is designed to be answered by a person and not a machine.

19. A method of a virtual email for blocking un-wanted electronic messages, comprising:
at least one user, said at least one user having a electronic address;
at least one electronic message sender;
a server for receiving electronic messages, said server having means to manage said electronic address for said at least one user as to allow said at least one user to receive electronic messages sent to said server in behalf of said at least one user;
said at least one user's electronic address is divided into two parts;
at least one part of said at least two parts of said at least one user's electronic address is an electronic address for identifying said server in a network;
at least one part of said at least two parts of said at least one user's electronic address is a user ID assigned to said at least one user and used by said server as a means for said server to identify said at least one user therein;
said server receives an electronic message from said at least one electronic message sender in behalf of said at least one user therein;
said received electronic message having a address of said at least one electronic message sender; and
said server having means to send a prompt back to said at least one electronic message sender wherein said prompt is designed to be answered by a person and not a machine.

20. The method of a virtual email according to claim 19 wherein said electronic message is an email.

21. A method for a virtual email format address book, comprising:
a address book for the virtual email format;
said address book having at least one virtual email;
said at least one virtual email having two parts;
at least one part of said at least two parts is an email server's address; and
at least one other part of said at least two parts having an email sender's ID and an email recipient's ID.

22. The virtual email format address book according to claim 21 further comprising:
said at least one other part of said at least two parts further having a filter's parameter ID.

23. The virtual email format address book according to claim 21 further comprising:
means to manage said address book wherein said means to manage includes means for deleting said at least one virtual email from said address book.

24. The virtual email format address book according to claim 21 further comprising:
means to manage said address book wherein said means to manage includes means for adding at least one additional virtual email into said address book.

25. A method of a virtual email format, comprising:
said virtual email format having two parts;
at least one part of said at least two parts is an email server's address; and
at least one other part of said at least two parts having an email sender's ID and an email recipient's ID.

26. The method of a virtual email format according to claim 25 further comprising:
said at least one other part of said at least two parts further having a filter's parameter ID.
